(19) United States
(12) Patent Application Publication
(10) Pub. No.: US 2023/0035890 A1
(43) Pub. Date: Feb. 2, 2023

(54) SYSTEMS AND METHODS FOR REMOTELY CONTROLLING THE OPERATION OF A HARVESTING IMPLEMENT FOR AN AGRICULTURAL HARVESTER

(71) Applicant: CNH Industrial America LLC, New Holland, PA (US)

(72) Inventors: Preston L. McKinney, Rebersburg, PA (US); Blaine R. Noll, Fleetwood, PA (US)

(73) Assignee: CNH Industrial America LLC

(21) Appl. No.: 17/386,040

(22) Filed: Jul. 27, 2021

(51) Int. Cl. A01D 41/127; G05D 1/00

(52) U.S. Cl. CPC A01D 41/127; G05D 1/0016; G05D 2201/0201

(57) ABSTRACT

In one aspect, a system for controlling the operation of harvesting implements configured for use with agricultural harvesters includes a harvesting implement configured to be supported relative to an agricultural harvester, and at least one user interface component supported on the harvesting implement. The user interface component(s) is configured to receive input commands associated with controlling an operation of the harvesting implement. The system also includes an implement-based controller supported on the harvesting implement and being communicatively coupled to the user interface element(s) such that the implement-based controller is configured to receive the input commands from the at least one user interface component.

### FIELD OF THE INVENTION

The present subject matter relates generally to harvesting implements for agricultural harvesters, and, more particularly, to systems and methods for remotely controlling the operation of a harvesting implement of an agricultural harvester, such as by controlling the operation of the harvesting implement from a location exterior of an operator's cab of the harvester.

### BACKGROUND OF THE INVENTION

A harvester is an agricultural machine that is used to harvest and process crops. For instance, a forage harvester may be used to cut and comminute silage crops, such as grass and corn. Similarly, a combine harvester may be used to harvest grain crops, such as wheat, oats, rye, barely, corn, soybeans, and flax or linseed. In general, the objective is to complete several processes, which traditionally were distinct, in one pass of the machine over a particular part of the field. In this regard, most harvesters are equipped with a detachable harvesting implement, such as a header, which cuts and collects the crop from the field and feeds it to the base harvester for further processing.

Conventionally, the operation of most harvesters requires substantial operational involvement and control by the operator. For example, with reference to the header of a combine, the operator is often required to adjust various operational parameters of the header. Typically, such adjustments must be made from the operator's cab (e.g., via the user interface provided within the cab). As such, when the operator is outside the cab (e.g., inspecting the header), the operator must climb back into the cab to adjust one or more header-related operational parameters. This process is often very time consuming for the operator, particularly when multiple header adjustments are required.

Accordingly, improved systems and methods for remotely controlling the operation of a harvesting implement of an agricultural harvester would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for controlling the operation of harvesting implements configured for use with agricultural harvesters. The system includes a harvesting implement configured to be supported relative to an agricultural harvester, and at least one user interface component supported on the harvesting implement. The user interface component(s) is configured to receive input commands associated with controlling an operation of the harvesting implement. The system also includes an implement-based controller supported on the harvesting implement and being communicatively coupled to the user interface element(s) such that the implement-based controller is configured to receive the input commands from the at least one user interface component.

In another aspect, the present subject matter is directed to an agricultural harvester including a chassis, an operator's cab supported by the chassis, and a harvesting implement coupled to a front end of the chassis. The harvester also includes at least one user interface component supported relative to the chassis and being directly accessible by a user exterior of the operator's cab. The user interface component(s) is configured to receive input commands associated with controlling an operation of the harvesting implement. Additionally, the harvester includes a controller communicatively coupled to the user interface element(s) such that the controller is configured to receive the input commands from the user interface(s) component. The controller being further configured to control the operation of the harvesting implement based at least in part on the input commands.

In a further aspect, the present subject matter is directed to a method for controlling the operation of harvesting implements configured for use with agricultural harvesters. The method includes receiving, with an implement-based controller supported on a harvesting implement of an agricultural harvester, an input command transmitted via at least one user interface component supported on the harvesting implement, the input command associated with controlling an operation of the harvesting implement. The method also includes transmitting, with the implement-based controller, data associated with the input command to a vehicle-based controller supported by a chassis of the agricultural harvester, the harvesting implement being supported at a front end of the chassis of the agricultural harvester. Additionally, the method includes controlling, with the vehicle-based controller, the operation of the harvesting implement based at least in part on the input command.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, partial sectional side view of one embodiment of an agricultural harvester in accordance with aspects of the present subject matter;

FIG. 2 illustrates a partial, schematic view of a harvesting implement, particularly illustrating the harvesting implement in association with components of one embodiment of a system for remotely controlling the operation of a harvesting implement in accordance with aspects of the present subject matter;

FIG. 3 illustrates another partial, schematic view of a harvesting implement, particularly illustrating the harvesting implement in association with components of another embodiment of a system for remotely controlling the operation of a harvesting implement in accordance with aspects of the present subject matter;

FIG. 4 illustrates yet another partial, schematic view of a harvesting implement, particularly illustrating the harvesting implement in association with components of yet another embodiment of a system for remotely controlling the operation of a harvesting implement in accordance with aspects of the present subject matter;

FIG. 5 illustrates a schematic view of one embodiment of components suitable for use within a system for remotely controlling the operation of a harvesting implement in accordance with aspects of the present subject matter; and

FIG. 6 illustrates a flow diagram of one embodiment of a method for remotely controlling the operation of a harvesting implement in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for remotely controlling the operation of a harvesting implement of an agricultural harvester. In several embodiments, one or more user interface components may be provided at a location exterior of the operator's cab of the harvester to allow a user or operator to provide input commands associated with controlling the operation of the harvesting implement while the operator is outside the cab. For instance, in one embodiment, the user interface component(s) may be directly supported on the harvesting implement (e.g., by being accessible along an outer wall or body of the harvesting implement) to allow the operator to provide input commands for controlling the operation of the harvesting implement. In addition to the implement-based user interface component(s) (or as an alternative thereto), one or more vehicle-based user interface components may be supported by the chassis of the harvester at any other suitable location exterior of the cab, such as at a location along the exterior of the harvester vehicle. The user interface component(s) (whether implement-based or vehicle-based) may be directly or indirectly communicatively coupled to a controller configured to control the operation of one or more implement-based components in response to the input command provided by the operator. For instance, in one embodiment, the controller may, in response to the input command, be configured to control the operation of an actuator that, in turn, controls the movement or positioning of one or more components of the harvesting implement.

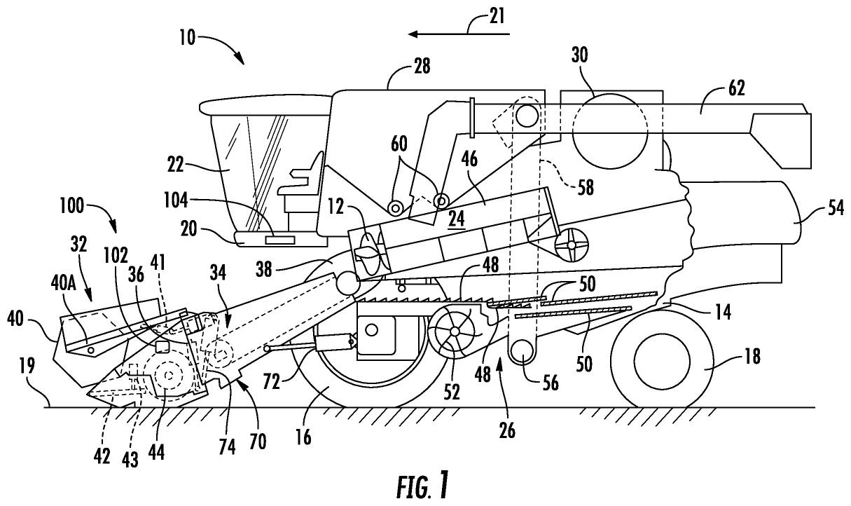

Referring now to the drawings, FIG. 1 illustrates a simplified, partial sectional side view of one embodiment of a work vehicle, such as an agricultural harvester 10. The harvester 10 may be configured as an axial-flow type combine, wherein crop material is threshed and separated while it is advanced by and along a longitudinally arranged rotor 12. The harvester 10 may include a main frame or chassis 14 having a pair of driven, ground-engaging front wheels 16 and a pair of steerable rear wheels 18. The wheels 16, 18 may be configured to support the harvester 10 relative to a ground surface 19 and move the harvester 10 in a forward direction of movement (indicated by arrow 21 in FIG. 1) relative to the ground surface 19. Additionally, an operator's platform 20 with an operator's cab 22, a threshing and separating assembly 24, a grain cleaning assembly 26 and a holding tank 28 may be supported by the chassis 14. Additionally, as is generally understood, the harvester 10 may include an engine and a transmission mounted on the chassis 14. The transmission may be operably coupled to the engine and may provide variably adjusted gear ratios for transferring engine power to the wheels 16, 18 via a drive axle assembly (or via axles if multiple drive axles are employed).

Moreover, as shown in FIG. 1, a harvesting implement (e.g., a header 32) and an associated feeder 34 may extend forward of the chassis 14 and may be pivotally secured thereto for generally vertical movement. In general, the feeder 34 may be configured to serve as support structure for the header 32. As shown in FIG. 1, the feeder 34 may extend between a front end 36 coupled to the header 32 and a rear end 38 positioned adjacent to the threshing and separating assembly 24. As is generally understood, the rear end 38 of the feeder 34 may be pivotally coupled to a portion of the harvester 10 to allow the front end 36 of the feeder 34 and, thus, the header 32 to be moved upwardly and downwardly relative to the ground 19 to set the desired harvesting or cutting height for the header 32.

In some embodiments, the header 32 includes a reel 40 rotatably coupled to a reel frame 40A which is, in turn, rotatably coupled to a frame of the header 32. The reel 40 is generally configured to contact crop material before a cutter bar 42 of the header 32. For instance, the reel 40 may include tines and/or the like such that, when crop materials contact the reel 40, the crop materials may be oriented into a substantially uniform direction and guided toward the cutter bar 42. The vertical positioning of the reel 40 (e.g., relative to the ground and/or chassis 14) may be adjusted by a reel actuator 41 coupled between the reel frame 40A and the feeder 34. For instance, the reel actuator 41 may be a cylinder which is extendable and retractable to adjust a vertical position of the reel 40. Additionally, the vertical positioning of the cutter bar 42 (e.g., relative to the ground and/or chassis 14) may be adjusted by a cutter bar actuator 43 supported by the header 32. For instance, the cutter bar actuator 43 may be a cylinder which is extendable and retractable to adjust a vertical position of the cutter bar 42.

As the harvester 10 is propelled forwardly over a field with standing crop, the crop material is directed towards the cutter bar 42 by the reel 40 and subsequently severed from the stubble by the cutter bar 42 at the front of the header 32 and delivered by a header auger 44 to the front end 36 of the feeder 34, which supplies the cut crop to the threshing and separating assembly 24. As is generally understood, the threshing and separating assembly 24 may include a cylindrical chamber 46 in which the rotor 12 is rotated to thresh and separate the crop received therein. That is, the crop is rubbed and beaten between the rotor 12 and the inner surfaces of the chamber 46, whereby the grain, seed, or the like, is loosened and separated from the straw.

Crop material which has been separated by the threshing and separating assembly 24 falls onto a series of pans 48 and associated sieves 50, with the separated crop material being spread out via oscillation of the pans 48 and/or sieves 50 and eventually falling through apertures defined in the sieves 50. Additionally, a cleaning fan 52 may be positioned adjacent to one or more of the sieves 50 to provide an air flow through the sieves 50 that removes chaff and other impurities from the crop material. For instance, the fan 52 may blow the impurities off of the crop material for discharge from the harvester 10 through the outlet of a straw hood 54 positioned at the back end of the harvester 10.

The cleaned crop material passing through the sieves 50 may then fall into a trough of an auger 56, which may be configured to transfer the crop material to an elevator 58 for delivery to the associated holding tank 28. Additionally, a pair of tank augers 60 at the bottom of the holding tank 28 may be used to urge the cleaned crop material sideways to an unloading tube 62 for discharge from the harvester 10.

Moreover, in several embodiments, the harvester 10 may also include a header height control system 70 which is configured to adjust a height of the header 32 relative to the ground surface 19 so as to maintain the desired cutting height between the header 32 and the ground surface 19. The system 70 may include a height actuator 72 configured to adjust the height or vertical positioning of the header 32 relative to the ground. For example, in some embodiments, the height actuator 72 may be coupled between the feeder 34 and the frame 14 such that the height actuator 72 may pivot the feeder 34 to raise and lower the header 32 relative to the ground 19. In addition, the header height control system 70 may include a tilt actuator(s) 74 coupled between the header 32 and the feeder 34 to allow the header 32 to be tilted relative to the ground surface 19 or pivoted laterally or side-to-side relative to the feeder 34. The height and tilt actuators 72, 74 may, for example, correspond to cylinders that are extendable and retractable to adjust the vertical positioning and tilt of the header 32.

Additionally, in accordance with aspects of the present subject matter, the harvester 10 may also include or be associated with a system 100 for remotely controlling the operation of a harvesting implement, such as the header 32 shown in FIG. 1. In several embodiments, the system 100 may include one or more user interface components 102, 104 provided at a location exterior of the operator's cab 22 that allow a user or operator to provide input commands associated with controlling the operation of the header 32. For instance, as shown in FIG. 1, one or more implement-based user interface components 102 may be supported on the header 32 for allowing the operator to provide input commands for controlling the operation of the header 32. In addition to the implement-based user interface component(s) 102 (or as an alternative thereto), one or more vehicle-based user interface components 104 may be supported by the chassis 14 of the harvester 10 at any other suitable location exterior of the cab 22, such as at a location along the exterior of the harvester vehicle (e.g., at the location on the operator's platform 20 as shown in FIG. 1). As will be described below, the input commands provided via the user interface component(s) 102, 104 may be used to control the operation of one or more components of the header 32 and/or any related systems and/or sub-systems of the harvester 10, such as the reel actuator 41, the cutter bar actuator 43, one or more components of the header height control system 70 (e.g., the height actuator 72 and/or the tilt actuator 74), and/or any other suitable components (e.g., a gauge wheel actuator (see FIG. 5) associated with a gauge wheel (not shown) of the header 32).

Referring now to FIGS. 2-4, schematic views of various different embodiments of a system 100 for remotely controlling the operation of a harvesting implement are illustrated in accordance with aspects of the present subject matter. In general, the various embodiments of the system 100 shown in FIGS. 2-4 will be described herein with reference to the header 32 illustrated in FIG. 1. However, it should be appreciated that the system 100 may be used to remotely control the operation of a harvesting implement having any other suitable configuration, including any other suitable header configuration.

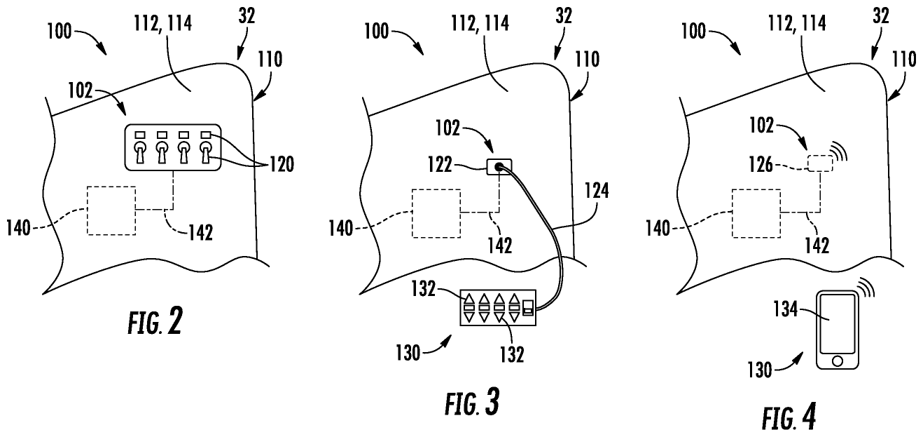

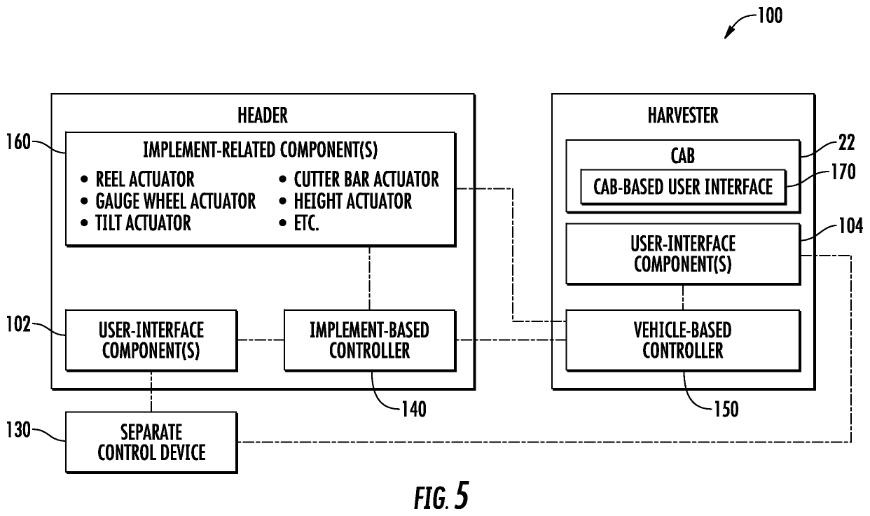

As shown in FIGS. 2-4, the system 100 may include one or more implement-based user interface components 102 configured to allow a user or operator to provide input commands associated with controlling the operation of the header 32. In several embodiments, the user interface component(s) 102 may be configured to be supported on the header, such as by being supported on or relative to a frame 110 of the header 32. For instance, in one or more embodiments, the user interface component(s) 102 may be mounted on or supported relative to an outer body or wall 112 of the header 32 such that the user interface component(s) 102 can be directly accessed and/or manipulated by an operator along an exterior of the header 32. Specifically, as shown in FIGS. 2 and 3, the user interface component(s) 102 may be supported relative to the outer wall 112 of the header frame 110 such that the component(s) 102 is positioned along or adjacent to an exterior surface 114 of the outer wall 112. Alternatively, the user interface component(s) 102 may be supported on or relative to the frame 110 of the header 32 at any other suitable location. For example, as shown in FIG. 4, the user interface component(s) 102 may be supported within the interior of the header 32, such as a location shielded or covered by the outer wall 112 of the header 32.

As particularly shown in FIG. 2, in one embodiment, the user interface component(s) 102 may include one or more user-manipulatable interface elements 120 for allowing an operator to provide input commands associated with controlling the operation of the header 32. In such an embodiment, the user-manipulatable interface element(s) 120 may correspond to any suitable interface elements, such as buttons, switches, knobs, sliders, dials, levers, touch screens, and/or the like, for providing operator inputs. As shown in FIG. 2, multiple interface elements 120 may be provided to allow the operator to control multiple components/functions on the header 32. For instance, each interface element 120 may allow the operator to control the operation of a different component/function of the header 32, such as a first interface element 120 for controlling the reel actuator 41, a second interface element 120 for controlling the cutter bar actuator 43, a third interface element 120 for controlling the gauge wheel actuator (see FIG. 5), a fourth interface element for controlling the height actuator 72, and so on.

In other embodiments, the user interface component(s) 102 may correspond to a communications-type component(s) configured to receive input commands from a control device 130 separate from the header, such as a remote control device. For instance, as shown in FIG. 3, in one embodiment, the user interface component(s) 102 may be configured as a communications port 122 (e.g., a USB port, optical port, firewire port, ethernet port, serial port, and/or the like) that allows a separate control device 130 to be communicatively coupled thereto via a wired connection (e.g., via communications link 124). Alternatively, as shown in FIG. 4, the user interface component(s) 102 may be configured as a wireless communications device 126 (e.g., a wireless receiver or transceiver) that allows a separate control device 130 to be communicatively coupled thereto via a wireless connection (e.g., by using any suitable wireless communications protocol, such as WiFi, Bluetooth, and/or the like).

In such embodiments, the separate control device 130 may correspond to any suitable portable or handheld device configured to be communicatively coupled to the communications port 122 via the wired connection (e.g., as shown in FIG. 3) or to the wireless communications device 126 via the wireless connection (e.g., as shown in FIG. 4), such as a dedicated remote control device or any other suitable device, such as a smartphone, tablet, and/or the like. When using a separate control device 130 to provide input comments, the control device 130 may include or incorporate one or more user-manipulatable interface elements for allowing an operator to provide input commands associated with controlling the operation of the header 32. For instance, as shown in FIG. 3, the separate control device 130 includes a plurality of different interface elements 132 for providing input commands, which can then be transmitted via the wired connection to the communications port 122. Similarly, as shown in FIG. 4, the separate control device 130 includes a touch-sensitive interface element (e.g., a touch screen 134) that allows the operator to provide input commands associated with controlling the header operation.

Referring still to FIGS. 2-4, in several embodiments, the disclosed system 100 may also include an implement-based controller 140 communicatively coupled to the user interface component(s) 102 (e.g., via a wired or wireless communications link 142), thereby allowing the input commands received at the user interface component(s) 102 to be transmitted to the controller 140. For instance, in the embodiment shown in FIG. 2, the implement-based controller 140 may be configured to receive input commands from the operator via the header-supported user-manipulable interface elements 120. Similarly, in the embodiments shown in FIGS. 3 and 4, the implement-based controller 140 may be configured to receive input commands from the operator via the communications port 122 (and the associated wired connection to the control device 130) or the wireless communications device 126 (and the associated wireless connection to the control device 130).

In general, the implement-based controller 140 may correspond to any suitable processor-based device(s), such as a computing device or any combination of computing devices. Thus, in several embodiments, the implement-based controller 140 may include one or more processor(s) and associated memory device(s) configured to perform a variety of computer-implemented functions. The memory device(s) may generally be configured to store suitable computer-readable instructions that, when implemented by the processor(s), configure the implement-based controller 140 to perform various computer-implemented functions.

In one embodiment, the implement-based controller 140 may be configured to receive the input commands transmitted from the user interface component(s) 120 and relay the input commands (or related instructions or control requests) to a separate controller for execution of the associated control action. For instance, as will be described below with reference to FIG. 5, the implement-based controller 140 may, in one embodiment, be configured to transmit the input commands (or related instructions or control requests) to a separate vehicle-based controller 150 (FIG. 5) of the harvester 10, which, in turn, may be configured to control the operation of the associated header component(s) in response to the operator-selected input command. In another embodiment, the implement-based controller 140 may be configured to execute the control actions, itself, in response to the operator-selected input command. For instance, in response to receiving an input command from the operator, the implement-based controller 140 may be configured to transmit suitable control commands to control the operation of the associated header component(s).

It should be appreciated that, although the different system embodiments shown in FIGS. 2-4 have generally been described separately, the various features of each system 100 may be combined in any suitable manner. For instance, in one embodiment, the system 100 may include implement-based interface elements 120 (e.g., as shown in FIG. 2) for allowing an operator to directly provide inputs via manipulation of the interface elements 120 and one or both of the communications port 122 (e.g., as shown in FIG. 3) and wireless communications device 126 (e.g., as shown in FIG. 4) to allow operator inputs to be communicated from the operator via a separate control device 130.

Referring now to FIG. 5, a schematic view of various components that can be included within one or more embodiments of a system 100 for remotely controlling the operation of a harvesting implement are illustrated in accordance with aspects of the present subject matter. The system 100 shown in FIG. 5 will generally be described herein with reference to the harvester 10 and header 32 illustrated in FIG. 1, as well as the system embodiments shown in FIGS. 2-4. However, it should be appreciated that the system 100 may be used to remotely control the operation of a harvesting implement having any other suitable configuration, including any other suitable header configuration, in association with a harvester having any other suitable harvester configuration.

As described above, the system 100 may, in several embodiments, include one or more implement-based user interface components 102 for receiving input commands associated with controlling the operation of the header 32 and an implement-based controller 140 communicatively coupled to the user interface component(s) 102, with both the user interface component(s) 102 and the implement-based controller 140 being supported on the header 32. For instance, the user interface component(s) 102 may include one or more user-manipulable interface elements supported directly on the header 32 (e.g., the interface elements 120 shown in FIG. 2) and/or one or more communications-type components supported on the header 32 that are configured to be communicatively coupled to a separate control device 130 via a wired or wireless connection (e.g., the communications port 122 shown in FIG. 3 and/or the wireless communications device 126 shown in FIG. 4)

The input commands received at the user interface component(s) 102 may then be transmitted to the implement-based controller 140 for subsequent processing and/or transmission. For instance, in one embodiment, the implement-based controller 140 may be configured to transmit control signals for controlling one or more of the implement-related components 160 of the harvester 10 in accordance with the input command(s) provided by the operator, such as by directly or indirectly controlling the operation of reel actuator 41, the cutter bar actuator 43, the gauge wheel actuator, height actuator 72, tilt actuator 74, and/or any other suitable component(s) based on the input command. For instance, if the operator provides an input command associated with raising or lowering the reel 40 or the cutter bar 42, the implement-based controller 140 may be configured to transmit suitable control signals to directly or indirectly control the operation of the associated actuator (e.g., when the actuator is a fluid-driven actuator, by controlling the operation of one or more control valves configured to regulate the flow of fluid supplied to the actuator).

In other embodiments, as indicated above, the implement-based controller 140 may be configured to relay the input commands provided by the operator (or related instructions or control requests) to a separate vehicle-based controller of the harvester 10, which, in turn, may be configured to control the operation of the associated header component(s) in response to the operator-selected input command. For instance, as shown in FIG. 2, a separate vehicle-based controller 150 may be provided on the harvester 10 for controlling the operation of one or more harvester components, such as the header 32, the threshing and separating assembly 24, the grain cleaning assembly 26, and/or the like. Thus, vehicle-based controller 150 may be configured to receive the input commands (or related instructions or control requests) from the implement-based controller 140 and subsequently transmit control signals for controlling one or more of the implement-related components of the harvester 10 in accordance with the input command(s), such as by directly or indirectly controlling the operation of reel actuator 41, the cutter bar actuator 43, the gauge wheel actuator, height actuator 72, tilt actuator 74, and/or any other suitable component(s) based on the input command(s).

It should be appreciated that the vehicle-based controller 150 may generally correspond to any suitable processor-based device(s), such as a computing device or any combination of computing devices. Thus, in several embodiments, the vehicle-based controller 150 may include one or more processor(s) and associated memory device(s) configured to perform a variety of computer-implemented functions. The memory device(s) may generally be configured to store suitable computer-readable instructions that, when implemented by the processor(s), configure the vehicle-based controller 150 to perform various computer-implemented functions.

As indicated above with reference to FIG. 1, in addition to the inclusion of one or more implement-based user-interface component(s) 102 that are supported on the header (or as alternative thereto), the system 100 may also include one or more vehicle-based user-interface component(s) 104 that are accessible at a location exterior of the cab (e.g., along an exterior wall or surface of the harvester 10) for allowing the operator to provide input commands when he/she is not located within the cab 22. Similar to the embodiments described above with reference to FIGS. 2-4, the vehicle-based user-interface component(s) 104 may include one or more user-manipulable interface elements supported on the harvester 10 at a location exterior of the cab 22 and/or one or more communications-type components supported on the harvester 10 at a location exterior of the cab 22 that are configured to be communicatively coupled to a separate control device 130 via a wired or wireless connection. As shown in FIG. 5, such vehicle-based user-interface component(s) 104 may be completely separate from the typical cab-based user interface 170 located within the cab 22 of the harvester 10.

In several embodiments, the vehicle-based user interface component(s) 104 may be communicatively coupled to the vehicle-based controller 150 (e.g., via a wired or wireless connection). Thus, in one embodiment, when the operator is interfacing with the vehicle-based user interface component(s) 104 to provide input commands associated with controlling the operation of the header 32, the vehicle-based controller 150 may be configured to receive the input commands from the user interface component(s) 104 and subsequently control one or more of the implement-related components in accordance with the input commands, such as by directly or indirectly controlling the operation of reel actuator 41, the cutter bar actuator 43, the gauge wheel actuator, height actuator 72, tilt actuator 74, and/or any other suitable header-related component(s) based on the input commands. Alternatively, the vehicle-based controller 150 may be configured to relay the input commands provided by the operator (or related instructions or control requests) to the implement-based controller 140, which, in turn, may be configured to control the operation of the associated header component(s) in response to the operator-selected input command.

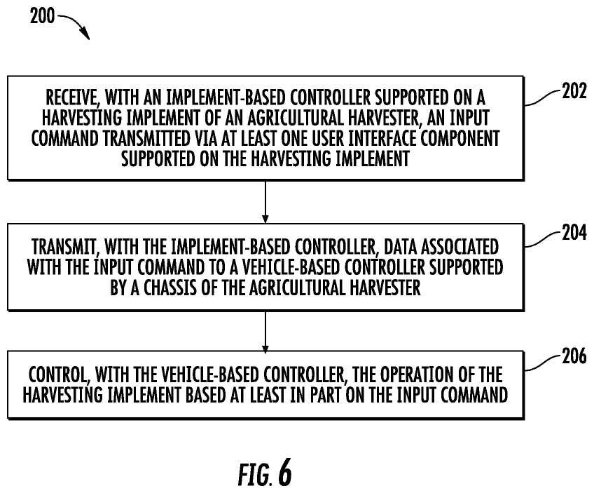

Referring now to FIG. 6, a flow diagram of one embodiment of a method 200 for remote controlling the operation of a harvesting implement is illustrated in accordance with aspects of the present subject matter. For purposes of discussion, the method 200 will generally be described herein with reference to the harvester 10 and header 32 shown in FIG. 1 and the various system components shown in FIGS. 2-5. However, it should be appreciated that the disclosed method 200 may be executed to remotely control the operation of a harvesting implement having any other suitable implement configuration and/or in association with any suitable system having any other suitable system configuration. Additionally, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, at (202) the method 200 may include receiving, with an implement-based controller supported on a harvesting implement of an agricultural harvester, an input command transmitted via at least one user interface component supported on the harvesting implement. For instance, as indicated above, one or more implement-based user interface components 102 may be supported on a harvesting implement (e.g., header 32) for receiving input commands from the operator. The input commands received at the user interface component(s) 102 can then be transmitted to an implement-based controller 140 for subsequent processing and/or transmission.

Additionally, at (204), the method 200 may include transmitting, with the implement-based controller, data associated with the input command to a vehicle-based controller supported by a chassis of the agricultural harvester. For instance, as described above, the implement-based controller 140 may, in some embodiments, be configured to transmit the input command (or related instructions or control requests) to a separate vehicle-based controller 150 of the harvester 10

Moreover, at (206), the method 200 may include controlling, with the vehicle-based controller, the operation of the harvesting implement based at least in part on the input command. Specifically, as described above, the vehicle-based controller 150 may, in some embodiments, be configured to control the operation of one or more implement-related component based on the input command, such as by directly or indirectly controlling the operation of reel actuator 41, the cutter bar actuator 43, the gauge wheel actuator, height actuator 72, tilt actuator 74, and/or any other suitable component(s) based on the input command.

It is to be understood that the steps of the method 200 are performed by a controller(s) (e.g., the implement-based controller 140 and/or the vehicle-based controller 150) upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller(s) described herein, such as the method 200, is implemented in software code or instructions which are tangibly stored on a tangible computer readable medium. The controller(s) loads the software code or instructions via a direct interface with the computer readable medium or via a wired and/or wireless network. Upon loading and executing such software code or instructions by the controller(s), the controller(s) may perform any of the functionality of the controller(s) described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for controlling the operation of harvesting implements configured for use with agricultural harvesters, the system comprising:
a harvesting implement configured to be supported relative to an agricultural harvester;
at least one user interface component supported on the harvesting implement, the at least one user interface component being configured to receive input commands associated with controlling an operation of the harvesting implement; and
an implement-based controller supported on the harvesting implement and being communicatively coupled to the at least one user interface element such that the implement-based controller is configured to receive the input commands from the at least one user interface component.

2. The system of claim 1, wherein the at least one user interface component comprises at least one user-manipulatable interface element supported on the harvesting implement to allow a user to provide the input commands.

3. The system of claim 1, further comprising a separate control device configured to be communicatively coupled to the implement-based controller via the at least one user interface component, the control device including at least one user-manipulatable interface element to allow a user to provide the input commands.

4. The system of claim 3, wherein the at least one user interface component comprises a communication port supported on the harvesting implement, the control device configured to be communicatively coupled to the communication port via a wired connection.

5. The system of claim 3, wherein the at least one user interface component comprises a wireless communications device supported on the harvesting implement, the control device configured to be communicatively coupled to the wireless communications device via a wireless connection.

6. The system of claim 1, wherein the implement-based controller is configured to transmit data to a vehicle-based controller of the agricultural harvester for controlling the operation of the harvesting implement based at least in part on the input commands received by the at least one user interface component.

7. The system of claim 1, wherein the implement-based controller is configured to directly control the operation of the harvesting implement based at least in part on the input commands received by the at least one user interface component.

8. The system of claim 1, wherein the input commands are associated with controlling an operation of an actuator configured to control movement or positioning of one or more components of the harvesting implement.

9. An agricultural harvester, comprising:
a chassis;
an operator's cab supported by the chassis;
a harvesting implement coupled to a front end of the chassis;
at least one user interface component supported relative to the chassis and being directly accessible by a user exterior of the operator's cab, the at least one user interface component being configured to receive input commands associated with controlling an operation of the harvesting implement; and
a controller communicatively coupled to the at least one user interface element such that the controller is configured to receive the input commands from the at least one user interface component, the controller being configured to control the operation of the harvesting implement based at least in part on the input commands.

10. The agricultural harvester of claim 9, wherein the at least one user interface component comprises at least one user-manipulatable interface element accessible by a user exterior of the operator's cab to allow the user to provide the input commands.

11. The agricultural harvester of claim 9, wherein the at least one user interface component comprises a communication port accessible by a user exterior of the cab, the communication port configured to be communicatively coupled to a separate control device via a wired connection for receiving the input commands from the control device.

12. The agricultural harvester of claim 9, wherein the input commands are associated with controlling an operation of an actuator configured to control movement or positioning of one or more components of the harvesting implement.

13. The agricultural harvester of claim 9, wherein the controller comprises a vehicle-based controller supported by the chassis.

14. A method for controlling the operation of harvesting implements configured for use with agricultural harvesters, the method comprising:
receiving, with an implement-based controller supported on a harvesting implement of an agricultural harvester, an input command transmitted via at least one user interface component supported on the harvesting implement, the input command associated with controlling an operation of the harvesting implement;
transmitting, with the implement-based controller, data associated with the input command to a vehicle-based controller supported by a chassis of the agricultural harvester, the harvesting implement being supported at a front end of the chassis of the agricultural harvester; and
controlling, with the vehicle-based controller, the operation of the harvesting implement based at least in part on the input command.

15. The method of claim 14, wherein the at least one user interface component comprises at least one user-manipulatable interface element supported on the harvesting implement and wherein receiving the input command comprises receiving the input command from the at least one-user manipulable interface element.

16. The method of claim 14, wherein receiving the input command comprises receiving the input command from a separate control device configured to be communicatively coupled to the implement-based controller via the at least one user interface component, the control device including at least one user-manipulatable interface element to allow a user to provide the input commands.

17. The method of claim 16 wherein the at least one user interface component comprises a communication port supported on the harvesting implement, the control device configured to be communicatively coupled to the communication port via a wired connection.

18. The method of claim 16, wherein the at least one user interface component comprises a wireless communications device supported on the harvesting implement, the control device configured to be communicatively coupled to the wireless communications device via a wireless connection.

19. The method of claim 14, wherein controlling the operation of the harvesting implement comprises controlling the operation of an actuator configured to control movement or positioning of one or more components of the harvesting implement.
